(19) United States
(12) Patent Application Publication
(10) Pub. No.: US 2014/0112114 A1
(43) Pub. Date: Apr. 24, 2014

(54) MAGNETIC RECORDING MEDIUM AND MAGNETIC STORAGE DEVICE

(71) Applicant: HITACHI, LTD., Tokyo (JP)

(72) Inventors: Junko USHIYAMA, Tokyo (JP); Harukazu MIYAMOTO, Tokyo (JP); Fumiko AKAGI, Tokyo (JP)

(73) Assignee: HITACHI, LTD., Tokyo (JP)

(21) Appl. No.: 14/060,691

(22) Filed: Oct. 23, 2013

(30) Foreign Application Priority Data
Oct. 23, 2012 (JP) 2012-233336

(51) Int. Cl. G11B 5/74

(52) U.S. Cl. CPC G11B 5/746
USPC 369/13.24; 428/800

(57) ABSTRACT

A magnetic recording medium includes a substrate and a magnetic recording layer formed on the substrate. The magnetic recording layer includes a recording region on which a magnetic material is formed as a bit pattern, and a spacing layer which fills a peripheral area of the recording region with a non-magnetic material with relatively higher thermal conductivity than that of the magnetic material.

### CLAIM OF PRIORITY

The present application claims priority from Japanese patent application JP 2012-233336 filed on Oct. 23, 2012 the content of which is hereby incorporated by reference into this application.

### BACKGROUND

The present invention relates to a magnetic recording medium for thermally assisted magnetic recording and a magnetic storage device using the magnetic recording medium.

A magnetic disk device installed in a computer as one of information storage systems for supporting the recent highly informed society has been in the rapid progression phase of high recording density, high data transmission rate and downsizing. In order to provide the magnetic disk device with high recording density, it is necessary to reduce the distance between the magnetic disk and the magnetic head, miniaturize the crystal grain which forms the magnetic film of the magnetic recording medium, increase the coercive force (anisotropic magnetic field) of the magnetic recording medium, and accelerate the signal processing.

For realizing the high recording density, the magnetic recording medium has been designed to reduce noise by miniaturizing the crystal grain size, forming a crystal grain boundary area between magnetic particles, and weakening magnetic bond between the magnetic particles. However, energy for retaining recording magnetization is proportional to the magnetic particle volume. Therefore, if the volume of the magnetic particle becomes small, resistance against the thermal energy is deteriorated (problem of heat fluctuation).

Bit patterned medium (BPM) have been focused as one of approaches for solving the aforementioned heat fluctuation problem. The approach is carried out by recording a single bit for a single particle. As the single bit is recorded in one of magnetic particles (cells) which are regularly arrayed, this approach allows the particle size to be increased to that of the bit approximately. This makes it possible to provide the medium with excellent heat resistance. The BPM are expected to have the heat fluctuation problem owing to further narrowing of the magnetic particle aimed at achieving the surface recording density equal to or higher than 5 Tb/in². It is therefore considered to be necessary for combining a high Kᵤ material such as FePt with the thermally assisted magnetic recording. For example, JP-A-2005-243186 discloses the combination of the bit patterned medium with the thermally assisted magnetic recording. JP-A-2005-243186 describes about the thermal control method which is important upon thermally assisted recording on the bit patterned medium. Specifically, a heat conductive layer with high thermal conductivity is formed at least on one side of the magnetic recording layer to suppress dispersion of the temperature distribution when heating the magnetic recording layer, and to suppress heat transfer to the adjacent bit by using a non-magnetic material with lower thermal conductivity than the thermal conductivity of the magnetic material for forming the spacing layer as the peripheral area of the bit formed of the magnetic material. JP-A-2006-196151 describes that the temperature control layer which is patterned adjacent to the magnetic recording layer, using materials with low thermal conductivity and high thermal conductivity, respectively. The material with low thermal conductivity is provided just below the bit, and the material with high thermal conductivity is provided just below the spacing layer around the bit so that the recording bit is efficiently heated.

In order to carry out the thermally assisted recording on the bit patterned medium, it is necessary to control the temperature distribution when heating the medium. Especially in order to realize the bit patterned medium corresponding to the super high recording density at the terabit level, it is necessary to heat the microscopic bit without giving an influence on the adjacent bit. For this, the steep temperature distribution has to be realized. As disclosed in OPTICS EXPRESS, Vol. 20, No. 17, p. 18946 (2012), the generally employed approach which has been considered has difficulties in obtaining the temperature distribution steeper than the absorption distribution of the irradiated light for heating.

### SUMMARY OF THE INVENTION

The present invention provides a bit patterned medium (magnetic recording medium) for thermally assisted magnetic recording, which exhibits a steep temperature distribution and allows recording without influencing the adjacent bit, and a magnetic storage device using such medium.

The magnetic recording medium has a magnetic recording layer on a substrate. The magnetic recording layer includes a recording region on which the magnetic material is formed as a bit pattern and a spacing layer that fills a peripheral area of the recording region with a first non-magnetic material with relatively higher thermal conductivity than the thermal conductivity of the magnetic material. The spacing layer is formed by using the non-magnetic material with thermal conductivity higher than that of the recording region so as to efficiently release heat in the heated bit to the spacing layer. This makes it possible to provide the steep temperature distribution irrespective of the micro bit.

The non-magnetic material for forming the spacing layer exhibits the thermal conductivity of 3 W/mK or higher, and more preferably, 6 W/mK or higher. Preferably, the material is substantially transparent with respect to the wavelength of the incident light so that the light for irradiating the magnetic recording medium is not absorbed by the spacing layer and heat is not generated. For example, an oxide that contains one of elements including Mg, In, Sn and Zn, or a mixture thereof may be employed as the material which satisfies the aforementioned conditions. According to the present invention, the aforementioned material is not limited so long as its thermal conductivity is relatively higher than that of the magnetic material for forming the recording region.

The magnetic recording medium has a magnetic recording layer on a substrate. The recording layer includes a recording region on which the magnetic material is formed as a bit pattern, a spacing layer which fills the peripheral area of the recording region with a first non-magnetic material, and a thin film interposed between the recording region and the spacing layer, and formed of a second non-magnetic material with relatively lower thermal conductivity than the thermal conductivity of the spacing layer. The thin film with the thermal conductivity lower than that of the spacing layer is provided around the recording region so as to allow efficient heating of the bit while suppressing spreading of the temperature distribution. It is preferable to use the material with the relatively lower thermal conductivity than that of the recording region as the second non-magnetic material for forming the thin film. Further preferably, the following relationship is established, that is, the second non-magnetic material for forming the thin film<the first non-magnetic material for forming the spacing layer<the magnetic material for forming the recording region.

The second non-magnetic material may be formed of the material which contains any one of elements including Fe, Co, Al, Si, Ti and Cr, for example, SiO₂, Al₂O₃ and Fe₂O₃. It is preferable to set the thickness of the thin film to be larger than 0 nm and equal to or smaller than 2 nm for efficiently heating the bit while suppressing spreading of the temperature distribution. If the thickness is larger than 2 nm, spreading of the temperature distribution is no longer negligible. Preferably, the second non-magnetic material is substantially transparent with respect to the irradiating light in use. However, the material does not have to exhibit transparency. In the case where the non-transparent thin film part absorbs the light, the volume of the thin film is small relative to the overall volume of the magnetic recording layer. Accordingly, the thin film with no transparency hardly influences the temperature distribution.

The recording region has a substantially cylindrical shape such as a circular, an elliptical and a capsule-like shape. Especially when the cross-section diameter is equal to or smaller than 6 nm, the significant effect of the present invention may be obtained. The bit patterned medium with the areal recording density of the recording region with the cross-section diameter larger than 6 nm, especially, 10 nm or larger still provides the effect of the present invention. However, such a case does not need the highly steep temperature distribution with full width half maximum (FWHM) of the temperature distribution equal to or smaller than 10 nm because of the low areal density. The present invention is significantly effective when the medium has a super-high density with the cross-section diameter equal to or smaller than 10 nm, especially 6 nm or smaller. The cross-section diameter represents the diameter of the circular cross-section. If the recording region has the cross-section other than the circular shape, the cross-section diameter represents the diameter in the down-track direction.

The recording region of the magnetic recording medium according to the present invention has a total area of the upper and lower surfaces smaller than the area of the side surface. If the recording density of the magnetic recording medium is smaller than 1 Tb/inch², for example, several hundreds of Gb/inch² approximately, the cross-section area of the recording region is large. This is effective for releasing excessive heat from the upper and lower surfaces of the recording region. As for the recording medium with high density, to which the present invention is applied, it has been clarified that the excessive heat release from the side surface is more effective than the heat release from the upper and lower surfaces of the recording region. The effect of the present invention is further marked especially when the side surface area is larger than the total area of the upper and lower surfaces twice or more.

It is preferable to use the FePt alloy or the CoPt alloy as the magnetic material for forming the recording region. The recording region may have a granular structure having those alloys divided with grain boundary phases such as SiO₂. An oxide other than SiO₂, for example, TiO₂, Al₂O₃, Ta₂O₅, ZrO₂ and TiO may be used as the grain boundary phase without changing the effect of the present invention. The magnetic material is not limited to those described above. Such material as SmCo may be used to provide the effect with no difference from that of the present invention.

It is important for the present invention to control heat that diffuses toward an in-plane direction which gives a great influence on the temperature distribution. Accordingly, the thermal conductivity in the in-plane direction of the recording region is essential. If the thermal conductivity of the recording region varies in accordance with the film thickness direction and the in-plane direction, the thermal conductivity in the in-plane direction is defined as that of the recording region according to the present invention.

As described above, the present invention realizes the thermally assisted bit patterned medium having the areal recording density at terabit level, and the magnetic storage device using such medium.

According to the invention, the magnetic recording medium of thermally assisted recording type ensures the steep temperature distribution in the recording region. This makes it possible to record the magnetism information without influencing the adjacent bit. The present invention is capable of providing the magnetic recording medium with high density and high reliability, and the magnetic storage device using the magnetic recording medium.

### BRIEF DESCRIPTION OF THE DRAWINGS

FIG. 1 is a schematic view illustrating an exemplary cross-section structure of a magnetic recording medium according to a first embodiment;

FIG. 2 schematically illustrates an exemplary planar structure of a magnetic recording layer according to the first embodiment, an upper part of which is a perspective view and a lower part of which is a plan view;

FIG. 3A illustrates a process of manufacturing the magnetic recording medium according to the first embodiment;

FIG. 3B illustrates the process of manufacturing the magnetic recording medium according to the first embodiment;

FIG. 3C illustrates the process of manufacturing the magnetic recording medium according to the first embodiment;

FIG. 3D illustrates the process of manufacturing the magnetic recording medium according to the first embodiment;

FIG. 3E illustrates the process of manufacturing the magnetic recording medium according to the first embodiment;

FIG. 4 represents calculation results of light absorption of the magnetic recording medium according to the first embodiment;

FIG. 5 represents calculation results of a temperature distribution of the magnetic recording medium according to the first embodiment;

FIG. 6 represents calculation results of the temperature distribution of a comparative medium relative to the magnetic recording medium according to the first embodiment;

FIG. 7 represents calculation results of recording on the magnetic recording medium according to the first embodiment;

FIG. 8 schematically illustrates an exemplary cross-section structure of a magnetic recording medium according to a second embodiment;

FIG. 9 is a graph representing a relationship between an FWHM of the temperature distribution of the magnetic recording medium according to the second embodiment, and the thermal conductivity of the spacing layer material;

FIG. 10 schematically illustrates an exemplary cross-section structure of a magnetic recording medium according to a third embodiment;

FIG. 11 schematically illustrates an exemplary planar structure of a magnetic recording layer according to the third embodiment;

FIG. 12 represents calculation results of light absorption of the magnetic recording medium according to the third embodiment;

FIG. 13 represents calculation results of the temperature distribution of the magnetic recording medium according to the third embodiment;

FIG. 14 is a graph representing a relationship between the thermal conductivity of the thin film material, and the maximum temperature in the recording region upon heating of the magnetic recording medium according to the third embodiment;

FIG. 15 is a graph representing a relationship between the thermal conductivity of the thin film material and the FWHM of the temperature distribution of the magnetic recording medium according to the third embodiment;

FIG. 16 is a graph representing a relationship between the thermal conductivity of the thin film material and the maximum temperature in the recording region upon heating of the magnetic recording medium according to the third embodiment;

FIG. 17 schematically illustrates an exemplary planar structure of a magnetic recording layer according to a fourth embodiment;

FIG. 18 is a graph representing a relationship between the thin film thickness and the FWHM of the temperature distribution of the magnetic recording medium according to the fourth embodiment;

FIG. 19 is a graph representing a relationship between the thin film thickness and the maximum temperature in the recording region of the magnetic recording medium according to the fourth embodiment;

FIG. 20 is a graph representing a relationship between a ratio of a total area of the upper and lower surfaces to a side surface area of the recording region, and the FWHM of the temperature distribution with respect to the bit diameter of a magnetic recording medium according to a fifth embodiment;

FIG. 21 is a graph representing a relationship between the ratio of the total area of the upper and lower surfaces to the side surface area of the recording region, and the FWHM of the temperature distribution with respect to the bit diameter of the magnetic recording medium according to the fifth embodiment;

FIG. 22 schematically illustrates an exemplary cross-section structure of a magnetic recording medium according to a sixth embodiment;

FIG. 23 is a graph representing each relationship between the diameter of the recording region and the FWHM of the temperature distribution of the magnetic recording medium according to the sixth embodiment, and the generally employed magnetic recording medium;

FIG. 24 is a graph representing a relationship between the ratio of the FWHM of the magnetic recording medium according to the sixth embodiment to that of the generally employed magnetic recording medium, and the diameter of the recording region;

FIG. 25 is a graph representing a relationship between the thermal conductivity of the area just below the recording region, and the ratio of the maximum temperature rise at the lower portion to the upper portion of the magnetic recording layer of the magnetic recording medium according to the sixth embodiment;

FIG. 26 schematically illustrates another exemplary cross-section structure of the magnetic recording medium according to the sixth embodiment;

FIG. 27 schematically illustrates another exemplary cross-section structure of the magnetic recording medium according to the sixth embodiment;

FIG. 28 schematically illustrates an exemplary structure of a magnetic storage device provided with the magnetic recording medium according to the respective embodiments; and

FIG. 29 schematically illustrates an exemplary structure of a thermally assisted magnetic write head provided with the magnetic recording medium according to the respective embodiments.

### DESCRIPTION OF THE PREFERRED EMBODIMENTS

Embodiments of the present invention will be described referring to the drawings.

### First Embodiment

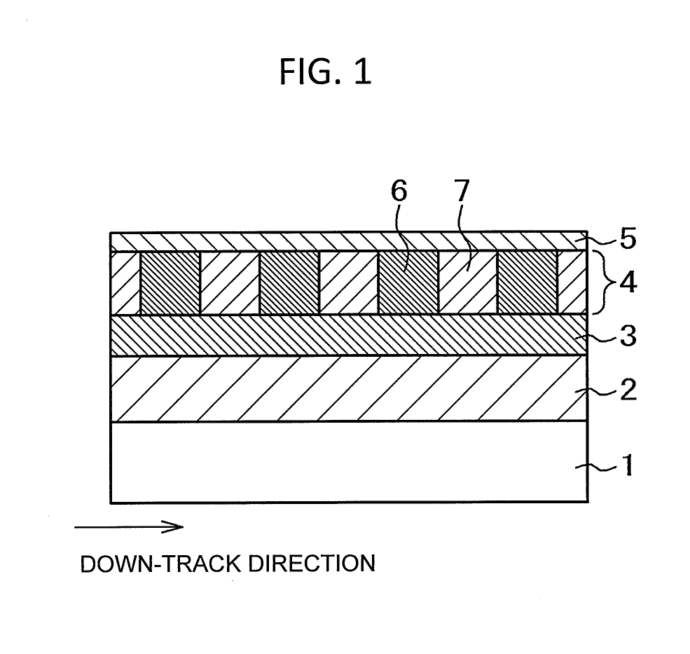

FIG. 1 schematically illustrates a magnetic recording medium according to a first embodiment of the present invention. The drawing shows a plane (sectional view) of the medium, which is defined by the film thickness direction and the medium running direction (down-track direction). Referring to the drawing, the magnetic recording medium includes a substrate 1, a metal layer 2, an underlayer 3, a magnetic recording layer 4 and a overcoat 5. The magnetic recording layer 4 includes a recording region 6 and a spacing layer 7. The recording region 6 is separated by the spacing layer 7. A non-magnetic material for forming the spacing layer exhibits thermal conductivity higher than that of the magnetic material for forming the recording region. Table 1 shows values of the thermal conductivity of the representative materials (thin film). In this embodiment, FePt is used for forming the recording region 6, and a magnesium oxide is used for forming the spacing layer 7.

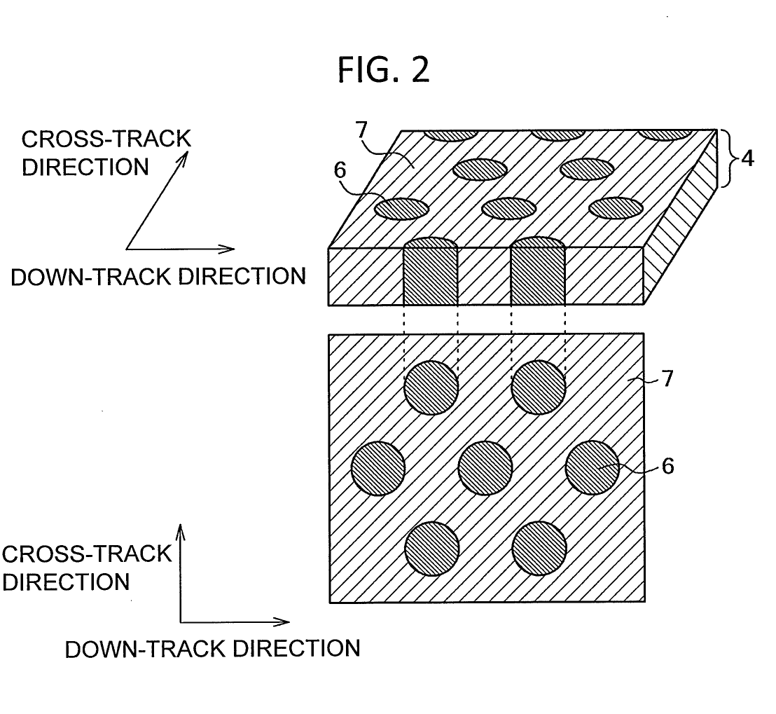

FIG. 2 schematically illustrates an exemplary planar structure of the magnetic recording layer according to the embodiment. An upper part of FIG. 2 is a perspective view and a lower part is a planar view. In this embodiment, the recording region has a circular planar shape with a diameter of 5.3 nm. The distance between the circles is set to 6 nm. The recording regions are arranged to form a hexagonal closest packing structure.

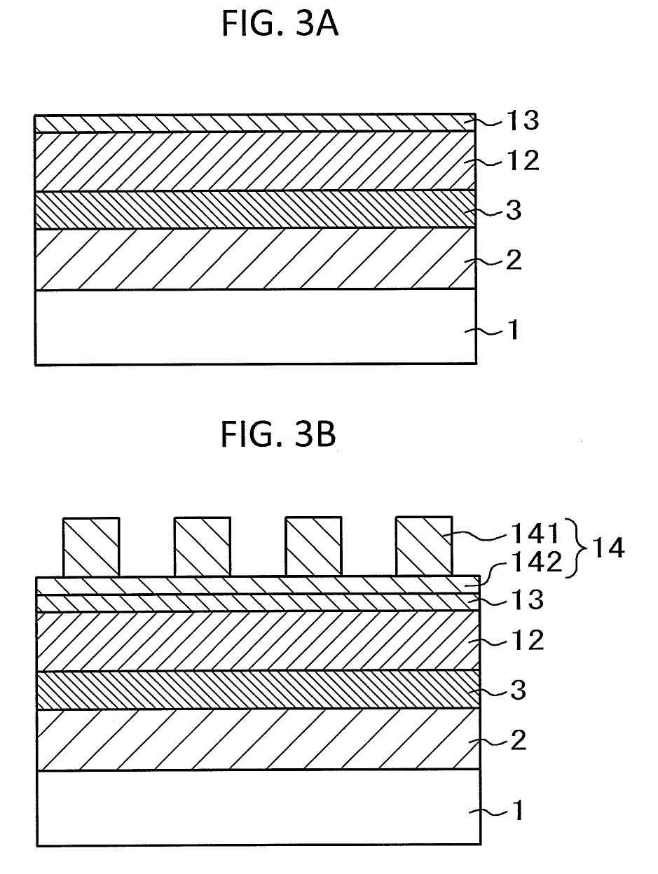

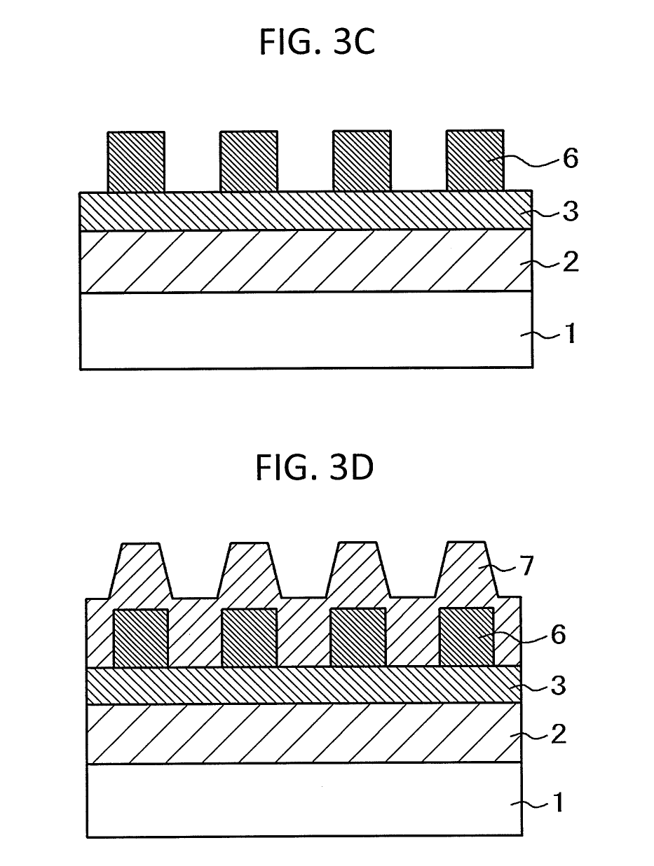

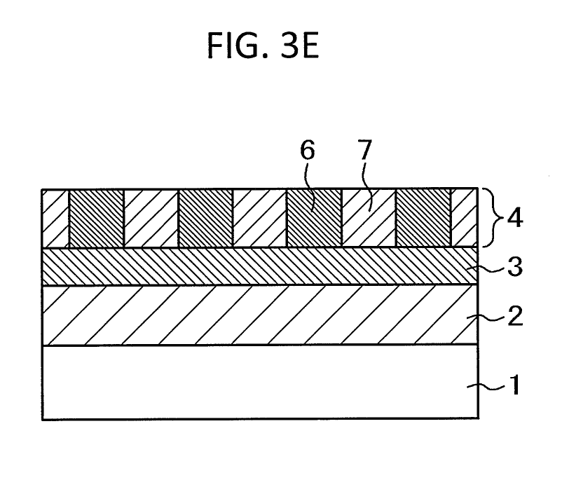

A method of manufacturing the magnetic recording medium according to the embodiment will be described referring to FIGS. 3A to 3E.

As FIG. 3A illustrates, the metal layer 2, the underlayer 3, and a magnetic layer 12 are sequentially formed on the substrate 1 using a sputtering method. Then a protective layer 13 is further formed. As FIG. 3B illustrates, a resist layer 14 having a resist pattern 141 is formed on the protective layer 13. Then as FIG. 3C illustrates, the resist pattern is transferred on the recording layer through an etching process using an inert gas such as Ar ion. Then a residual resist (residue of the resist) 142 and the protective layer 13 are removed through a reactive ion etching process. At this time, use of hydrogen gas makes it possible to remove them without altering the surface of the recording layer. As FIG. 3D illustrates, the material is filled by covering the pattern so as to form a spacing layer 7 using sputtering. As FIG. 3E illustrates, the surface of the spacing layer 7 is planarized through the reactive ion etching or the ion etching using the inert gas. Subsequently, the spacing layer is trimmed through the ion etching using the inert gas, and then the overcoat 5 and a lubrication layer (not shown in the drawing) are formed to manufacture the magnetic recording medium as FIG. 1 shows.

TABLE 1
Thermal Conductivity Data of Various Types of Materials (W/mK)

| Material | Thermal conductivity |
|---|---|
| Cu | 200 |
| FePt | 2.9 |
| CoPd | 3.3 |
| Indium tin oxide | 8 |
| Magnesium oxide | 4 |
| Zinc oxide | 6 |
| Silicon oxide | 0.9 |
| Aluminum oxide | 1.7 |

More specifically, a glass substrate with diameter of 65 mm is used for forming the substrate 1. A Cu layer with thickness of 100 nm for forming the metal layer 2, a magnesium oxide with thickness of 5 nm for forming the underlayer 3, and a FePt alloy with thickness of 6 nm for forming the magnetic layer 12 are laminated on the glass substrate. The protective layer 13 is formed using a sputtering carbon with thickness of 4 nm. Then the imprint resist pattern 14 is formed using an imprint device. The resist pattern 14 has the total thickness of 25 nm, and the pattern 141 has the height of 20 nm. The resist residue 142 has a thickness of 5 nm. The resist pattern may be formed through photolithography using the exposure device.

Etching is performed in oxygen gas using the reactive ion etching device so as to remove the resist residue 142 and the protective layer 13 which form the recess of the resist pattern. Then the magnetic layer 12 is etched using Ar ion beam while allowing the resist to serve as the mask. Etching is performed in hydrogen gas using the reactive ion etching device so as to remove the remaining resist and the protective layer 13. The magnesium oxide is formed into the film as the filter layer, and the etching device is operated to reduce the surface difference of the filter layer to 1.5 nm or smaller. The ion beam etching device is operated to etch the spacing layer using the Ar ion beam so as to remove the non-magnetic spacing layer (magnesium oxide layer) on the recording region. Secondary ion mass spectrometry detects Fe, and performs etching until the detected amount reaches the value twice or more than the background. The sputtering device is operated to form the carbon overcoat 5 with thickness of 1 nm, and a lubricating layer (not shown in the drawing).

The thus produced magnetic recording medium according to this embodiment includes recording regions which are magnetically separated alternately on the substrate of the disk.

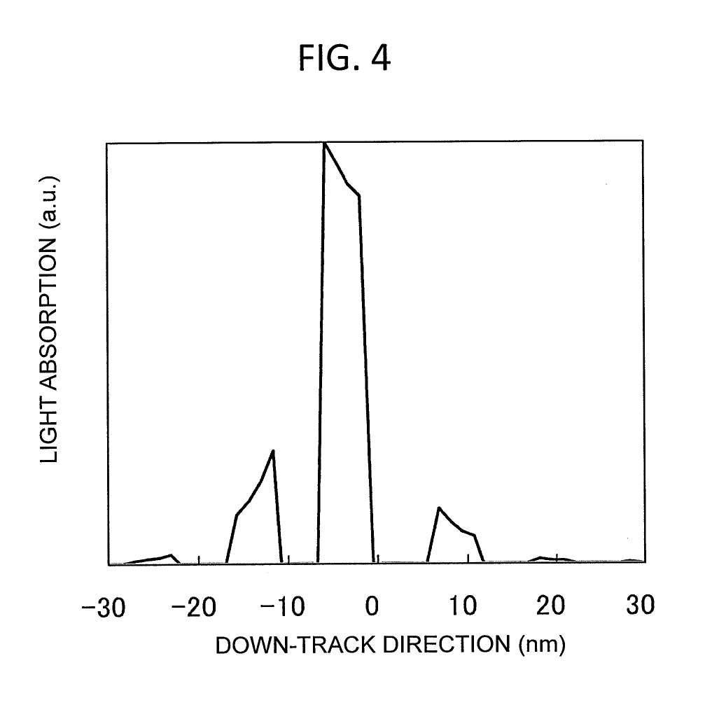

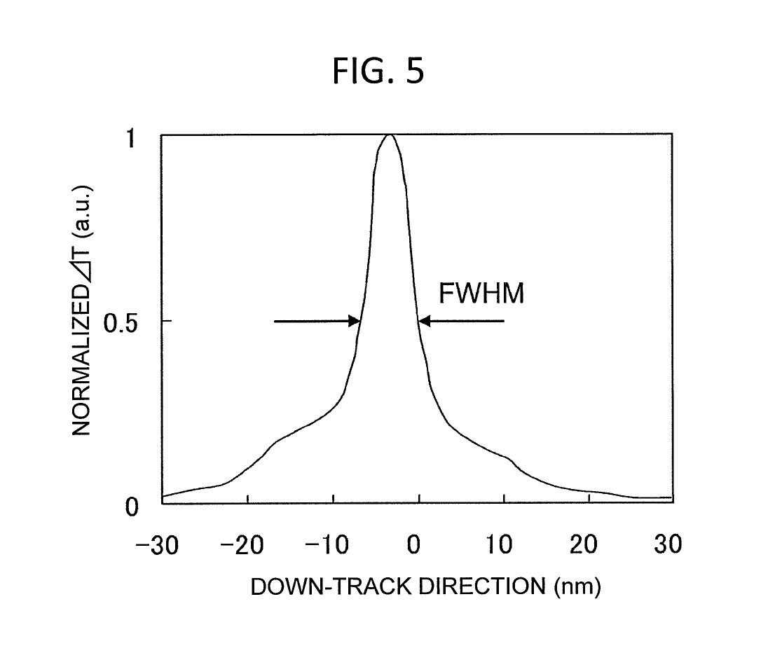

The known light/thermal-propagation tool is used to carry out a heat propagation analysis through light irradiation so as to calculate distribution of light absorption in the magnetic recording medium produced according to the embodiment. Results of the heat propagation analysis using the light absorption as a heat source are shown in FIGS. 4 and 5. FIG. 4 represents the light absorption distribution at the center of the magnetic recording layer in a down-track direction, and FIG. 5 represents the temperature distribution at the center of the magnetic recording layer in the down-track direction. The FWHM of the temperature distribution measures 6.5 nm.

The magnetic recording medium as related art in reference to the embodiment is produced by using the silicon oxide with low thermal conductivity for forming the spacing layer. The magnesium oxide used for forming the spacing layer according to the embodiment has the thermal conductivity of 4 W/mK, and the silicon oxide used for forming the spacing layer as related art has the thermal conductivity of 0.9 W/mK. The FePt alloy as the material for forming the recording region has the thermal conductivity of 2.9 W/mK. The respective values of the thermal conductivity as described above establish the relationship of silicon oxide<FePt alloy<magnesium oxide. The configuration and materials of the magnetic recording medium according to another related art are the same as those of the magnetic recording medium according to the embodiment.

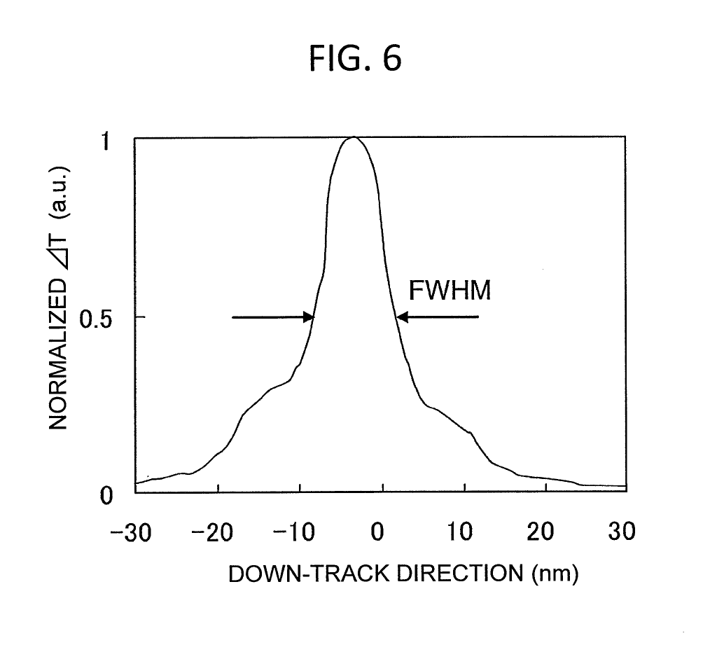

Like the embodiment, the known light/thermal-propagation tool is used to carry out the light propagation analysis and heat propagation analysis. FIG. 6 represents results of the temperature distribution calculation at the center of the magnetic recording layer of the comparative medium in the down-track direction. The FWHM value of the temperature distribution measures 9.6 nm (1.5 times larger than the value of the case using the magnesium oxide). The embodiment shows that use of the spacing layer with high thermal conductivity realizes the steep temperature distribution.

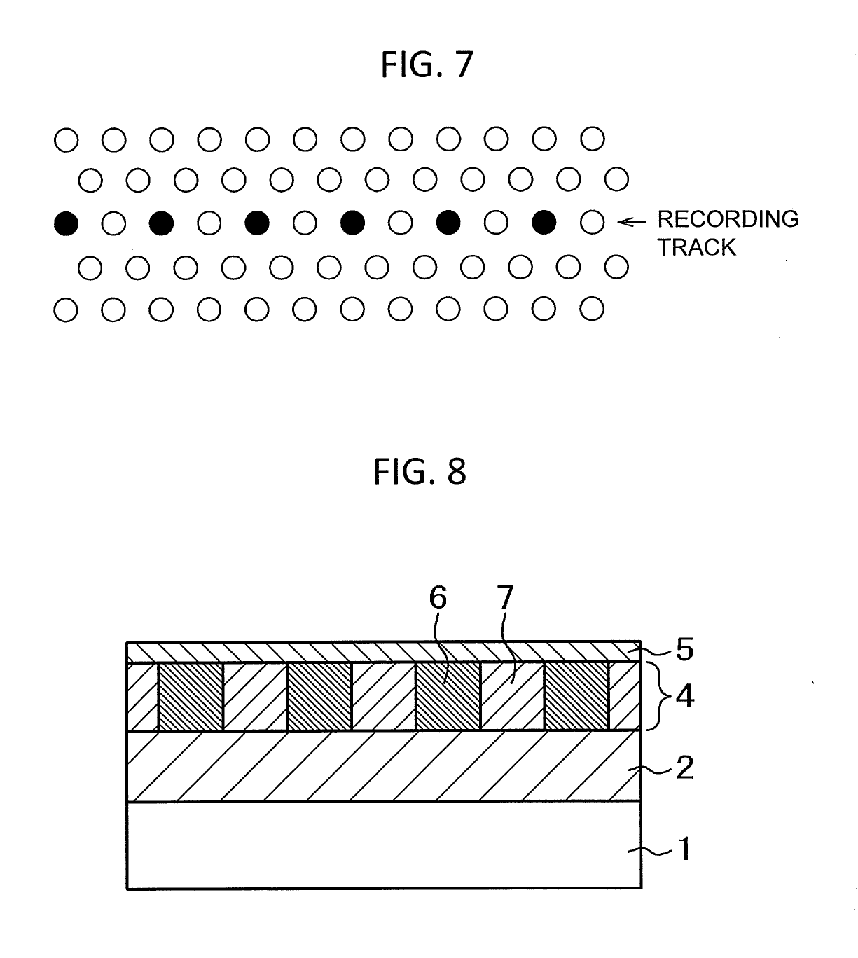

Explanation will be made with respect to verification results of recording to the medium according to the embodiment through calculator simulation unit using the known micro-magnetics. The calculation is carried out by using the known Landau-Lifshitz-Gilbert equation. FIG. 7 shows simulation results. The drawing represents the plane of the recording regions defined by the down-track direction and the cross-track direction. Referring to the drawing, the white circle indicates an upward magnetization of the recording region. It is assumed that magnetization of all the recording regions is directed upward before recording (initial magnetization state). The black circle indicates a downward magnetization of the recording region. The calculation is carried out on the assumption that the number of the recording regions is obtained by calculation of 32×8. The drawing only illustrates the peripheral area of recording. The calculation is carried out for recording so that the upward magnetized recording regions and the downward magnetized recording regions are alternately arranged on the recording region of the recording track. As FIG. 7 clearly indicates, it is confirmed that the upward magnetized recording regions marked with white circles and the downward magnetized recording regions marked with black circles are alternately arranged on the recording track. It is also confirmed that there is no influence on the recording region adjacent to those on the recording track, for example, such as error recording on the adjacent recording region.

In this embodiment, the FePt alloy film is used as the magnetic material for forming the recording region 6. Use of high Ku perpendicular magnetic anisotropy material such as a CoCr alloy film, a CoPd alloy film, a CoPt alloy film, a SmCo alloy film, a Co/Pd multi-layer film, and a Co/Pt multi-layer film provides effects similar to those of the embodiment as a result of using the spacing layer with relatively higher thermal conductivity than the recording region. In this embodiment, the magnesium oxide is used as the non-magnetic material for forming the spacing layer. Use of a zinc oxide, an indium tin oxide and the like may retain the effects of the present invention so long as the non-magnetic material has the relatively higher thermal conductivity than that of the magnetic material for forming the recording region. Those materials are transparent with respect to the light wavelength in use, and no light absorption contributes to the steep temperature distribution.

In this embodiment, Cu is used for forming the metal layer. However, materials other than Cu, for example, Pt, Au and NiTa may provide the same effects as those of the present invention. Although the magnesium oxide is used for forming the underlayer, materials other than the magnesium oxide, for example, oxides such as an alumina, a silicon oxide, a tungsten oxide and a tantalum oxide, nitrides such as an aluminum nitride and a titanium nitride, or mixture of the oxide and nitride may be used so as to provide the similar effects to those of the present invention without limitation. The effects of the present invention may be obtained irrespective of use of such metal as Cu, Al, Au, Ag, Pt, Ru and Ni, any alloy thereof, mixture of the metal, oxide, nitride and the like.

In this embodiment, the recording regions are arranged to form the hexagonal closest packing structure in the spacing layer at the bit aspect ratio of 0.87. However, according to the present invention, the arrangement of the recording regions is not limited to the hexagonal closest packing structure. The bit aspect ratio is not also limited.

The magnetic recording medium configured as illustrated in FIG. 1 provides high recording density and high reliability.

The embodiment is capable of providing the magnetic recording medium of thermally assisted recording type, which allows the steep temperature distribution in the recording region, and recording of the magnetism information without influencing the adjacent bit. The embodiment further provides the magnetic recording medium with high density and high reliability.

### Second Embodiment

In this embodiment, an explanation will be made with respect to the temperature distribution change resulting from use of various types of spacing layer materials. Any feature described in the first embodiment, which is not described herein is applicable unless the circumstances are exceptional.

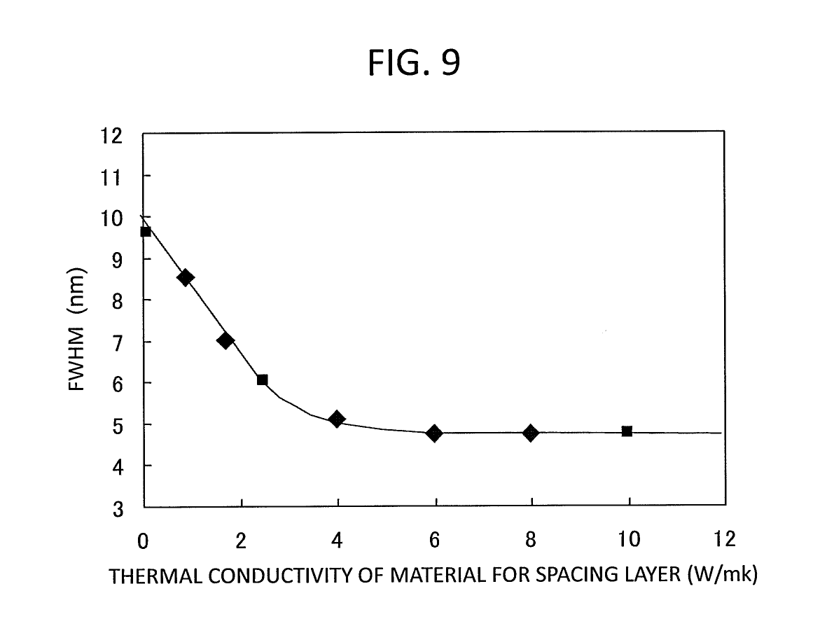

FIG. 8 schematically shows a cross-section structure of the magnetic recording layer according to the second embodiment. Like the first embodiment, the recording region has a circular planar shape with a diameter of 5.3 nm. The distance between the circles is 6 nm. The recording regions are arranged to form the hexagonal closest packing structure. The manufacturing method of the magnetic recording layer will be omitted herein as it is the same process as described in the first embodiment. The magnetic recording medium according to this embodiment includes the substrate 1, the metal layer 2 formed of Cu with thickness of 70 nm, the magnetic recording layer 4, and the overcoat 5 formed of a carbon. The magnetic recording layer 4 includes the recording region 6 and the spacing layer 7. The FePt alloy is used for forming the recording region 6, and five types of materials including the silicon oxide, aluminum oxide, magnesium oxide, zinc oxide, and indium tin oxide as shown in Table 1 are used for forming the spacing layer 7. Calculation is carried out on the assumption that materials with thermal conductivity values of 0.1 W/mK, 2.5 W/mK and 10 W/mK are used to increase the calculation points. FIG. 9 shows calculation results. The black rhombic mark denotes the FWHM of the temperature distribution resulting from use of five different materials, and the black square mark denotes the FWHM of the temperature distribution resulting from use of the assumed material. As the graph indicates, it is confirmed that the FWHM of the temperature distribution becomes small as the thermal conductivity of the spacing layer material is increased. The graph shows a marked feature that the rate of reduction in the FWHM changes at a point corresponding to the thermal conductivity of approximately 3 W/mK. The FWHM changes by 1.5 nm approximately with respect to the thermal conductivity of 2.5 W/mK or lower in comparison with the thermal conductivity of 1 W/mK. Meanwhile, in comparison with the case of the thermal conductivity of 1 W/mK, the FWHM changes by 0 to 0.2 nm approximately in the case of the thermal conductivity of 4 W/m or higher. Especially when the thermal conductivity is 6 W/mK or higher, the FWHM is kept substantially constant, and the effect of the steep temperature distribution is saturated at a point corresponding to 6 W/mK or higher. Accordingly, it is preferable to select the material for forming the spacing layer with the thermal conductivity of 3 W/mK or higher, and more preferable to select the material with the thermal conductivity of 6 W/mK or higher. Specifically, it is preferable to use the transparent material which contains any one of Mg, In, Sn and Zn as the spacing layer material. For example, the magnesium oxide, indium tin oxide, zinc oxide and the like are non-magnetic materials each with the thermal conductivity of 3 W/mK or higher. Those materials with transparency to the wavelength of light for thermally assisting are favorable because they do not absorb light in the region other than the recording region, and do not generate unnecessary heat upon recording.

The magnetic recording medium configured as illustrated in FIG. 8 provides high recording density and high reliability.

This embodiment provides the similar effects to those of the first embodiment. The greater effect may be obtained by setting the thermal conductivity of the spacing layer material to 3 W/mK or higher.

### Third Embodiment

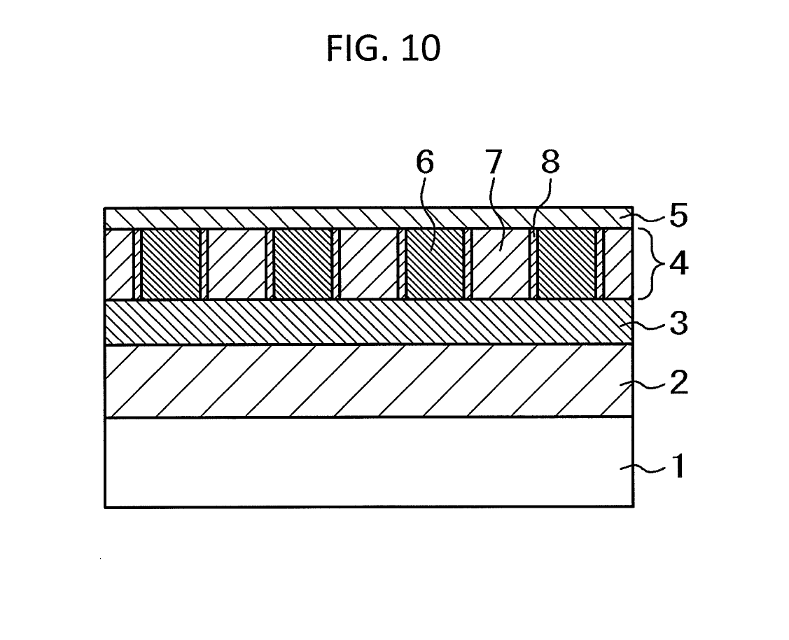

A third embodiment of the present invention will be described referring to FIGS. 10 to 16. Any feature described in the first or the second embodiment which is not described herein is applicable unless the circumstances are exceptional.

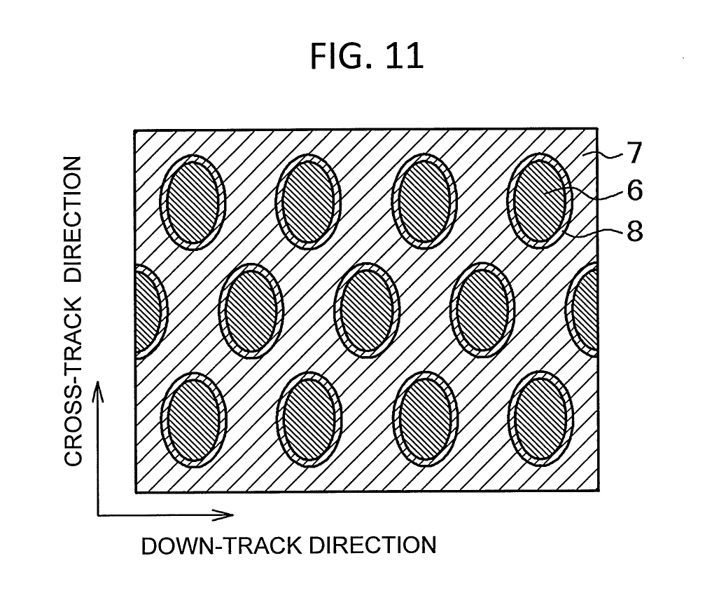

FIG. 10 is a sectional view of the magnetic recording medium in the down-track direction according to the third embodiment. The magnetic recording medium illustrated in FIG. 10 includes the metal layer 2, the underlayer 3, the magnetic recording layer 4, and the overcoat 5 on the substrate 1. The magnetic recording layer 4 includes the recording region 6, the spacing layer 7 and a thin film 8. The thin film formed of a material with relatively lower thermal conductivity than that of the material for forming the spacing layer is formed on the side surface of the recording region. In this embodiment, the glass substrate is used for forming the substrate 1, NiTa with thickness of 50 nm is used for forming the metal layer 2, Cu with thickness of 50 nm is used for forming the underlayer 3, the FePt alloy is used for forming the recording region 6, the zinc oxide is used for forming the spacing layer 7, and the silicon oxide is used for forming the thin film 8. The magnetic recording layer has the film thickness of 8 nm. FIG. 11 schematically illustrates an example of a planar structure of the magnetic recording layer according to the embodiment. In this embodiment, the recording region has a long elliptical cross-section in the cross-track direction, having a longer diameter of 6.8 nm and a shorter diameter of 4.9 nm. The distance between the ellipses is 4.8 nm in the down-track direction, and the thin film 8 has the film thickness of 1 nm.

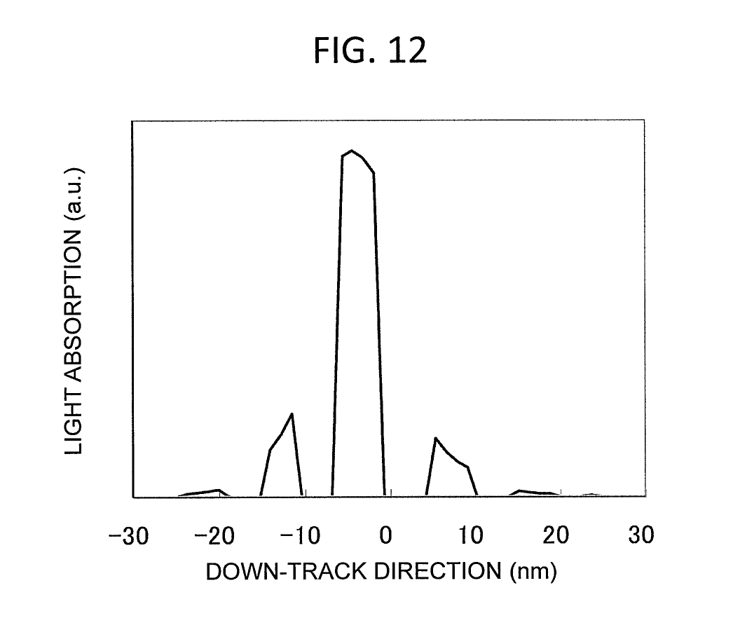

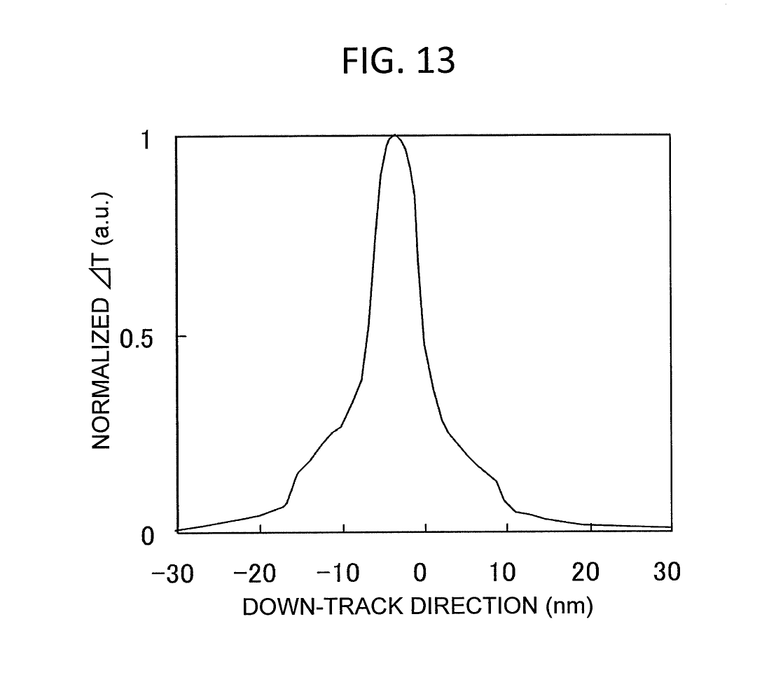

The known light/thermal-propergation simulation tool is used to carry out a light propagation analysis through light irradiation so as to calculate light absorption distribution in the magnetic recording medium produced according to the embodiment. The heat propagation analysis is carried out by using the light absorption as the heat source. FIGS. 12 and 13 represent the analytical results as described above. FIG. 12 shows the light absorption distribution in the down-track direction at the center of the magnetic recording layer. FIG. 13 shows the temperature distribution in the down-track direction at the center of the magnetic recording layer. As FIG. 12 indicates, the thin film 8 does not absorb light rays because of its transparency, and absorbs light rays only in the recording region like the magnetic recording medium according to the first embodiment. FIG. 13 shows the temperature distribution in the down-track direction, presenting the FWHM of 6.8 nm.

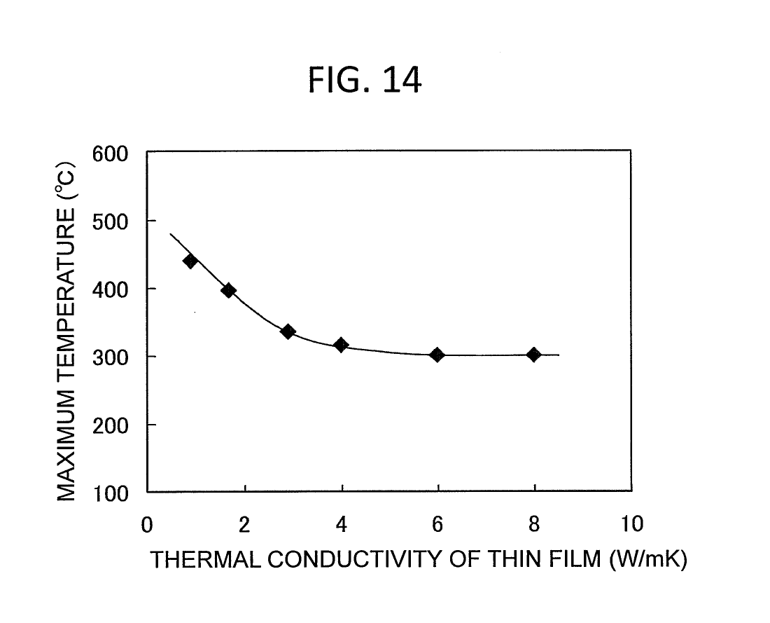

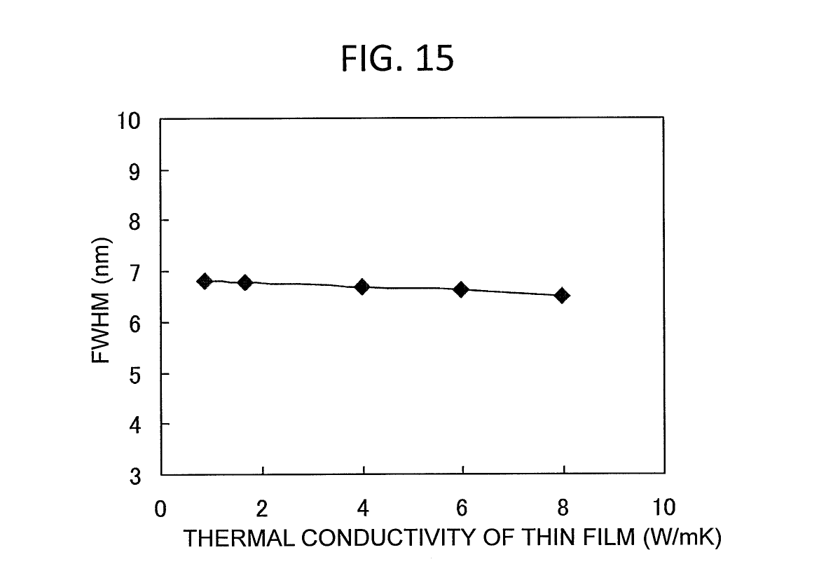

It is preferable to form the thin film 8 by using a material with relatively lower thermal conductivity than the material for forming the spacing layer. The magnetic recording media each having the thin film formed by using various types of non-magnetic materials are prepared, and the respective temperature distributions are calculated. FIG. 14 represents a relationship between the thermal conductivity of the thin film material and the maximum temperature in the recording region upon heating. In this embodiment, the zinc oxide with thermal conductivity of 6 W/mK is used for forming the spacing layer. It has been clarified that use of the material with thermal conductivity of 6 W/mK or lower for forming the thin film increases the maximum temperature. This indicates that the thin film formed of the material with the relatively lower thermal conductivity than the spacing layer material functions in heating the recording region more efficiently. FIG. 15 represents the relationship between the thermal conductivity of the thin film material and the FWHM of the temperature distribution. It is clarified that decrease in the thermal conductivity of the thin film to be lower than that of the spacing layer fails to largely increase the FWHM of the temperature distribution. In this way, the thin film with lower thermal conductivity than the spacing layer is provided between the recording region and the spacing layer so that the recording region is efficiently heated while suppressing an increase in the FWHM.

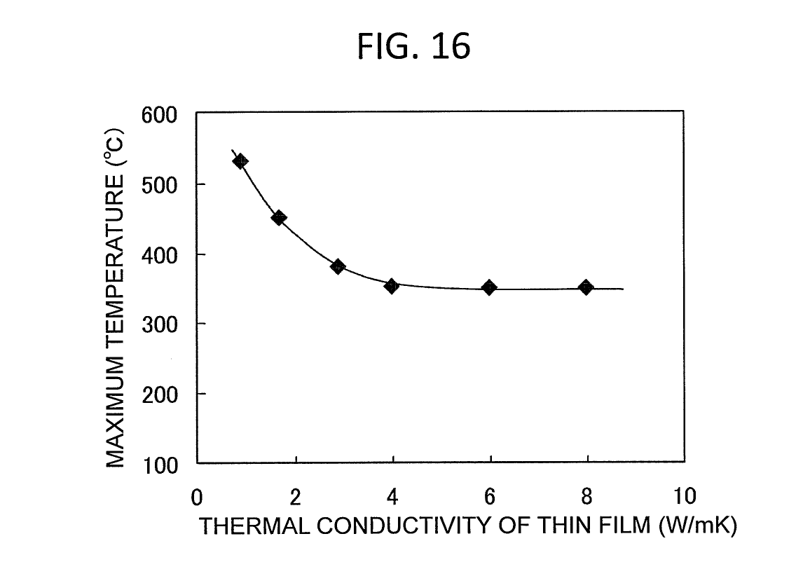

In this embodiment, the zinc oxide with thermal conductivity of 6 W/mK is used for forming the spacing layer. However, even if the material for forming the spacing layer is changed, the resultant effect hardly changes. FIG. 16 represents the relationship between the thermal conductivity of the thin film and the maximum temperature of the magnetic recording medium using the magnesium oxide with thermal conductivity of 4 W/mK for forming the spacing layer. Use of the thin film with thermal conductivity lower than 4 W/mK of the spacing layer increases the maximum temperature. This may realize effective heating of the recording region. In this case, a large increase in the FWHM of the temperature distribution is not observed.

FIGS. 14 and 16 clearly show that the thin film with thermal conductivity lower than that of the recording region contributes to a significant increase in the maximum temperature when using the arbitrary spacing layer material. Accordingly, it is preferable to form the thin film 8 by using the material with the relatively lower thermal conductivity than that of the recording region.

The magnetic recording medium configured as illustrated in FIGS. 10 and 11 achieves high recording density and high reliability.

This embodiment is capable of providing the similar effects to those of the first embodiment. The thin film with low thermal conductivity is provided between the recording region and the spacing layer so as to heat the recording region efficiently.

### Fourth Embodiment

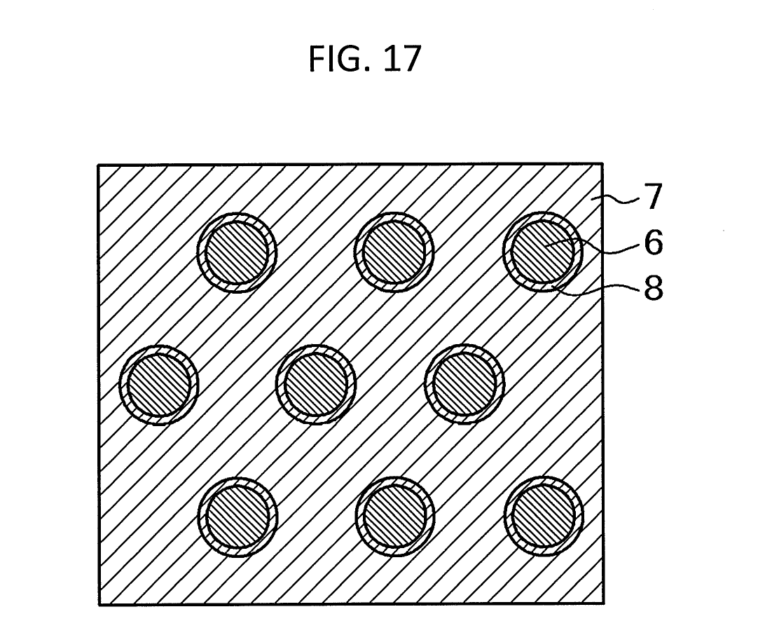

A fourth embodiment will be described referring to FIGS. 17 to 19. Any feature described in the first to the third embodiments which is not described herein is applicable unless the circumstances are exceptional.

FIG. 17 schematically illustrates an example of a planar structure of the magnetic recording layer produced according to the embodiment. In this embodiment, the recording region has a circular planar shape with diameter of 8 nm. The distance between the circles is 10 nm. Like the second embodiment, the laminated structure of the magnetic recording medium according to the embodiment includes the substrate 1, the metal layer 2 formed of Cu with film thickness of 80 nm, the magnetic recording layer 4 with film thickness of 10 nm, and the overcoat 5 with film thickness of 1.5 nm. The magnetic recording layer 4 includes the recording region 6, the spacing layer 7, and the thin film 8. The FePt alloy is used for forming the recording region 6, the indium tin oxide is used for forming the spacing layer 7, and the iron oxide with thermal conductivity of 2 W/mK is used for forming the thin film 8, respectively.

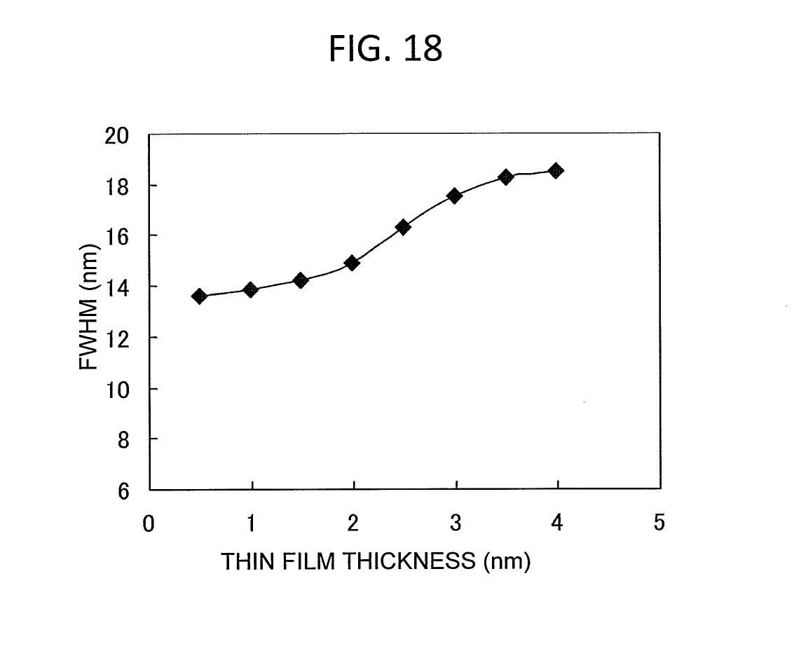

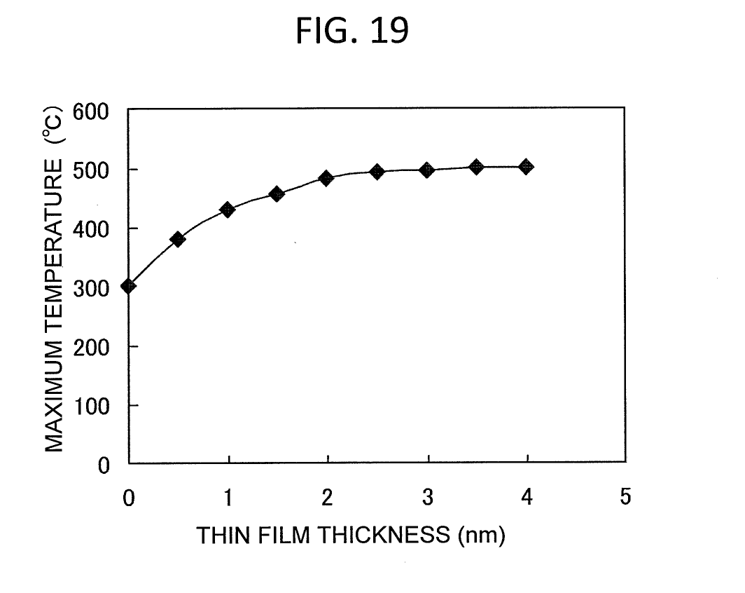

FIGS. 18 and 19 represent change in the FWHM of the temperature distribution, and change in the maximum temperature in the recording region, respectively in accordance with the different thickness of the thin film 8. If the thin film thickness is 2 nm or smaller, the maximum temperature in the recording region may be increased while suppressing an increase in the FWHM. If the thin film thickness exceeds 2 nm, the FWHM increases, and accordingly, an increase rate of the maximum temperature is lowered. It is therefore preferable to set the thin film thickness to 2 nm or smaller.

In this embodiment, the iron oxide is used for forming the thin film 8. However, besides the iron oxide, the non-magnetic material such as a cobalt oxide, an aluminum nitride, an aluminum oxide, a silicon nitride, a titanium oxide, a titanium nitride and a chrome oxide may be used for forming the thin film to provide the similar effects to those of the present invention. Mixture of those oxides or nitrides, or combination of different materials may also be used for forming the thin film so as to obtain the desired thermal conductivity.

The magnetic recording medium configured as illustrated in FIG. 17 is produced to provide the high recording density and high reliability.

This embodiment also provides the similar effects to those of the third embodiment. The thickness of the thin film with low thermal conductivity, which is interposed between the recording region and the spacing layer, is set to a finite value equal to or smaller than 2 nm so as to allow efficient heating of the recording region.

### Fifth Embodiment

This embodiment explains the relationship between the total area of the upper and lower surfaces and the side surface area of the recording region. Any feature described in the first to the fourth embodiments which is not described herein is applicable unless the circumstances are exceptional.

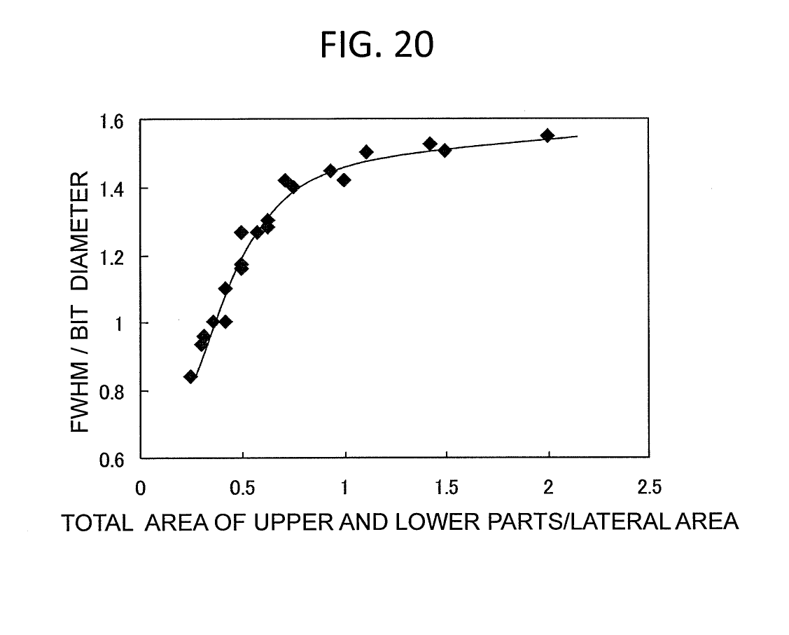

The magnetic recording medium according to this embodiment has the metal layer 2, the underlayer 3, the magnetic recording layer 4 and the overcoat 5 on the substrate 1. The magnetic recording layer 4 includes the recording region 6 and the spacing layer 7. In this embodiment, a glass substrate is used for forming the substrate 1, Ag with thickness of 100 nm is used for forming the metal layer 2, the silicon oxide with thickness of 50 nm is used for forming the underlayer 3, the CoPd alloy is used for forming the recording region 6, and the indium tin oxide is used for forming the spacing layer 7. Each of the recording regions has a circular planar shape, and are arranged to form the hexagonal closest packing structure. Twenty kinds of the magnetic recording media, having the film thickness of the magnetic recording layer varied in the range from 4 to 25 nm, and the bit diameter varied in the range from 3.8 to 20 nm are prepared, and subjected to the calculation of the light absorption and the temperature distribution, respectively. Specifically, it is assumed that twenty pairs of (film thickness, bit diameter) are set to (4, 5), (5, 5), (6, 5), (8, 5), (10, 5), (5, 10), (8, 10), (10, 10), (12, 10), (14, 10), (5, 15), (8, 15), (10, 15), (13, 15), (15, 15), (25, 15), (5, 20), (7, 20), (9, 20) and (14, 20) so as to form the recording regions. FIG. 20 is a graph, taking the ratio between the total area of the upper portion in contact with the overcoat and the lower portion in contact with the underlayer, and the side surface area in the recording region of those magnetic recording media (total area of upper and lower surfaces/side surface area) as an x-axis, and the FWHM of the temperature distribution normalized with the bit diameter as a y-axis. The FWHM is normalized using the bit diameter to allow comparison with respect to the effect of the steep temperature distribution among the magnetic recording media with different bit diameters. It is clarified that the smaller the normalized FWHM is made, the steeper the temperature distribution becomes. FIG. 20 clearly shows that the normalized FWHM becomes small as decrease in the ratio of the total area of the upper and lower surfaces to the side surface area. It is clarified that when the total area of the upper and lower surfaces to the side surface area is 1 or smaller, the significant effect for reducing the FWHM is obtained. In other words, as for the magnetic recording medium having the spacing layer formed of the material with relatively larger thermal conductivity than the material for forming the recording region, the effect of the steep temperature distribution may be enhanced by making the total area of the upper and lower surfaces of the recording region to be smaller than the side surface area of the recording region.

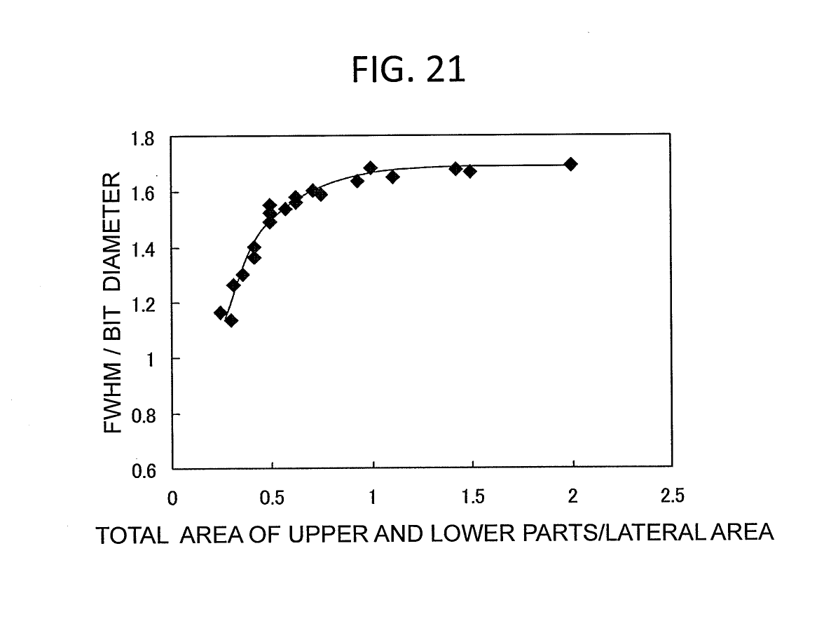

Assuming that the material for forming the spacing layer of the magnetic recording medium according to this embodiment is changed to the magnesium oxide, FIG. 21 represents the relationship between the ratio of the total area of the upper and lower surfaces to the side surface area, and the normalized FWHM. In the case where the magnesium oxide is used for forming the spacing layer according to the embodiment, the normalized FWHM becomes small when the ratio of the total area of the upper and lower surfaces to the side surface area is equal to or smaller than 1. However, use of the magnesium oxide with the thermal conductivity more approximate to that of the material for forming the recording region than the indium tin oxide with the thermal conductivity of 8 W/mK provides the low heat releasing effect. The effect of reducing the normalized FWHM becomes remarkable when the ratio of the total area of the upper and lower surfaces to the side surface area is equal to or smaller than 0.5. In other words, the recording region may be configured to have the ratio between the total area of the upper and lower surfaces and the side surface area of the recording region, which is equal to or smaller than 0.5, thus ensuring to provide a sufficient effect for realizing the steep temperature distribution.

The magnetic recording medium produced as described in this embodiment realizes the high recording density and high reliability.

The present embodiment is capable of providing the similar effects to those of the first embodiment. The total area of the upper and lower surfaces of the recording region is made smaller than its side surface area so as to realize the steep temperature distribution.

### Sixth Embodiment

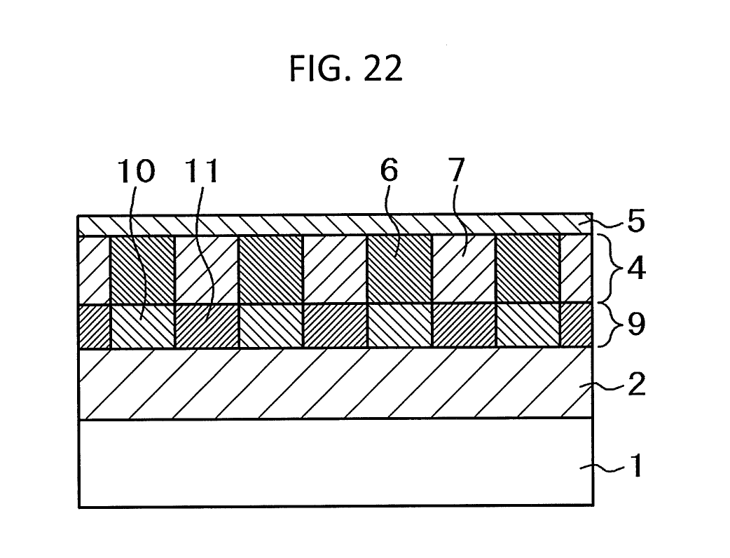

A sixth embodiment will be described referring to FIGS. 22 to 27. Any feature described in the first to the fifth embodiments which is not described herein is applicable unless the circumstances are exceptional.

FIG. 22 illustrates an exemplary layer structure of the magnetic recording medium produced according to the embodiment. The magnetic recording medium employed in the embodiment includes the metal layer 2, a temperature control layer 9, the magnetic recording layer 4, and the overcoat 5 on the substrate 1. The magnetic recording layer 4 includes the recording region 6 and the spacing layer 7. In this embodiment, the glass substrate is used for forming the substrate 1, Cu with thickness of 100 nm is used for forming the metal layer 2, the FePt alloy is used for forming the recording region 6, and the indium tin oxide is used for forming the spacing layer 7. The temperature control layer 9 includes a dielectric layer 10 and a metal layer 11. The magnesium oxide is used for forming the dielectric layer 10 and Cu is used for forming the metal layer 11. Each of the recording regions has a circular planar shape, and those regions are arranged to form the hexagonal closest packing structure. The magnetic recording layer has the film thickness of 8 nm. Then eight kinds of the magnetic recording media each with a different bit diameter ranging from 3.5 to 15 nm are prepared to be subjected to the calculation of the light absorption and the temperature distribution. For comparison, the magnetic recording medium using the silicon oxide with low thermal conductivity for forming the spacing layer is prepared to carry out the similar calculation.

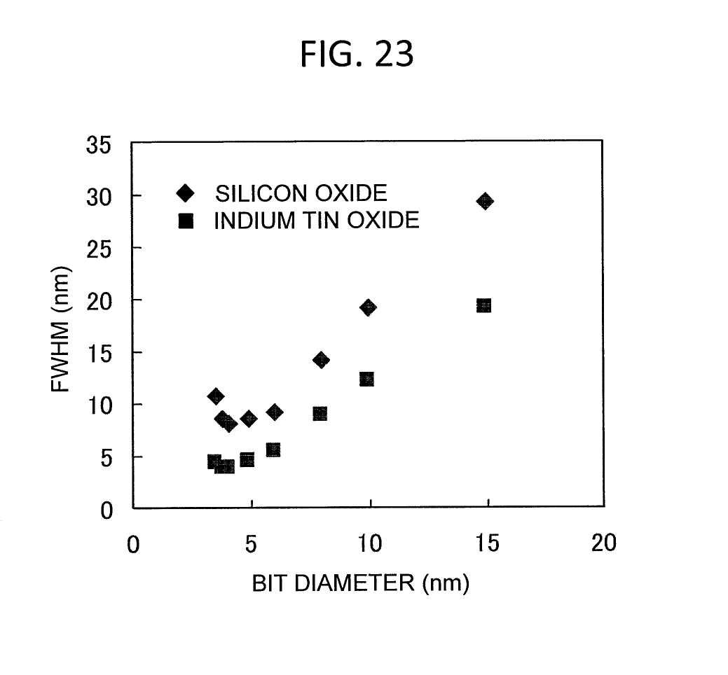

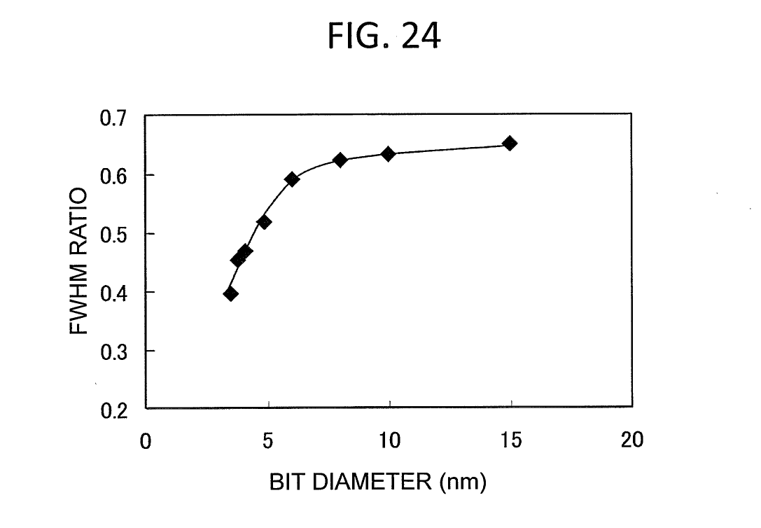

FIG. 23 represents the FWHM-dependent property presented upon change in the bit diameter. It is confirmed that use of the indium tin oxide (black square mark) with high thermal conductivity for forming the spacing layer makes the FWHM narrow in comparison with use of the silicon oxide (black rhombic mark). The FWHM is minimized when the bit diameter is approximately 4 nm, and starts increasing when the bit diameter is smaller than 4 nm, in other words, the temperature distribution is widened. When using the indium tin oxide for forming the spacing layer of the magnetic recording medium according to this embodiment, the increase rate becomes small. The magnetic recording medium with the bit diameter of 3.5 nm has a very narrow FWHM of 4.2 nm. The FWHM ratio of the generally employed magnetic recording medium to the one produced according to the embodiment is calculated to obtain the effect of the steep FWHM of the magnetic recording medium according to the embodiment using the indium tin oxide for forming the spacing layer in comparison with the generally employed magnetic recording medium using the silicon oxide for forming the spacing layer. FIG. 24 represents the calculation results. When the bit diameter is equal to or smaller than 6 nm, the FWHM ratio becomes significantly small. That is, it is confirmed that setting the bit diameter to 6 nm or smaller further enhances the steep temperature distribution effect. In this way, combination of the spacing layer with high thermal conductivity with the bit with diameter of 6 nm or smaller may enhance the effects of this embodiment.

In this embodiment, the recording region has a circular planar shape. However, the effects of the embodiment hardly change even if the planar structure is formed into any other cylindrical shape, for example, an elliptical shape and a capsule-like shape. In this case, it is essential to ensure that the diameter in the down-track direction has a narrower distance between bits than the diameter in the cross-track direction. The x-axis of the graph shown in FIG. 24 corresponds to the bit diameter in the down-track direction.

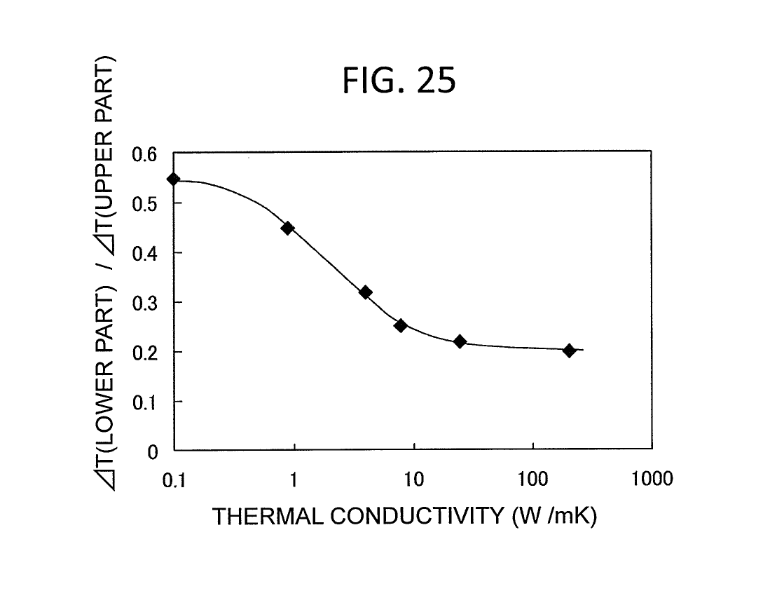

In this embodiment, the temperature control layer formed of a plurality of materials is provided adjacent to the magnetic recording layer. A dielectric with low thermal conductivity is provided just below the recording region, and the metal with high thermal conductivity is provided just below the spacing layer. Preferably, the thermal conductivity of the dielectric is lower than that of the material for forming the spacing layer. FIG. 25 represents the effect of the temperature control layer. Referring to the graph, the x-axis denotes the thermal conductivity of the area just below the recording region in the temperature control layer, and the y-axis denotes the ratio of the maximum temperature increase of the upper part (upper portion of the magnetic recording layer with a depth of 0.5 nm toward the magnetic recording layer from the interface between the magnetic recording layer and the overcoat) to the lower part (lower portion of the magnetic recording layer with a depth of 0.5 nm toward the magnetic recording layer from the interface between the magnetic recording layer and the temperature control layer). The temperature ratio represents the temperature difference in the film thickness direction in the magnetic recording layer. The value more approximate to 1 indicates that the magnetic recording layer is heated more uniformly. As the thermal conductivity of the area just below the recording region in the temperature control layer becomes 8 W/mK or lower, corresponding to the thermal conductivity of the indium tin oxide used for forming the spacing layer, the temperature ratio is increased. This may further enhance the effect for heating the recording region more uniformly. Accordingly, it is preferable to set the thermal conductivity of the material for forming the area just below the recording region to the value smaller than the thermal conductivity of the spacing layer. It is preferable to set the thermal conductivity of the area just below the spacing layer to the value higher than the thermal conductivity of the material for forming the spacing layer. The thermal conductivity of the area just below the spacing layer is made higher than the thermal conductivity of the material for forming the spacing layer, thus ensuring to make the temperature distribution further steeper.

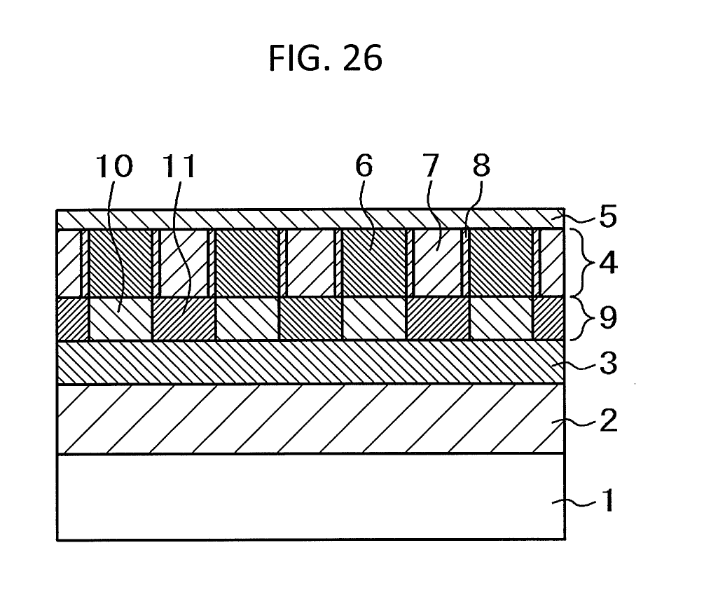

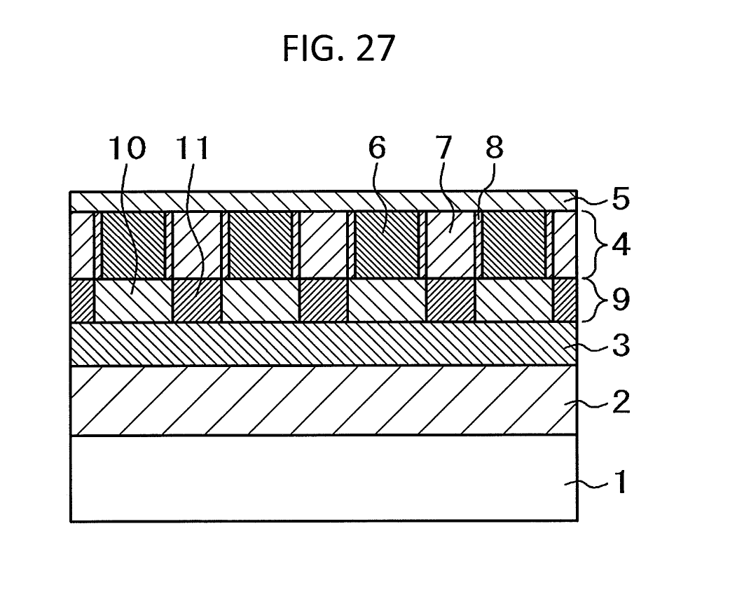

The magnetic recording medium with the thin film 8 provides the effect of uniformizing the temperature of the recording region without being changed. In this case, the thin film 8 may be provided on the metal layer 11 in the temperature control layer 9 as illustrated in FIG. 26, or may be provided on the dielectric layer 10 as illustrated in FIG. 27.

The magnetic recording medium configured as illustrated in FIG. 22 ensures the high recording density and high reliability.

This embodiment is capable of providing the magnetic recording medium of thermally assisted recording type, which makes it possible to provide the steep temperature distribution in the recording region, and to record the magnetism information without giving an influence on the adjacent bit. The resultant magnetic recording medium also provides high recording density and high reliability. The temperature control layer is provided adjacent to the magnetic recording layer so as to further enhance the effect of the steep temperature distribution.

### Seventh Embodiment

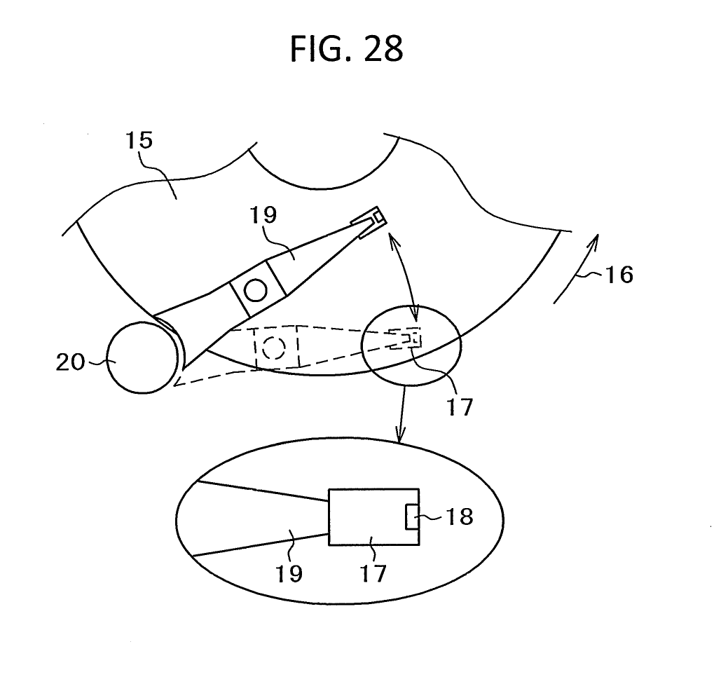

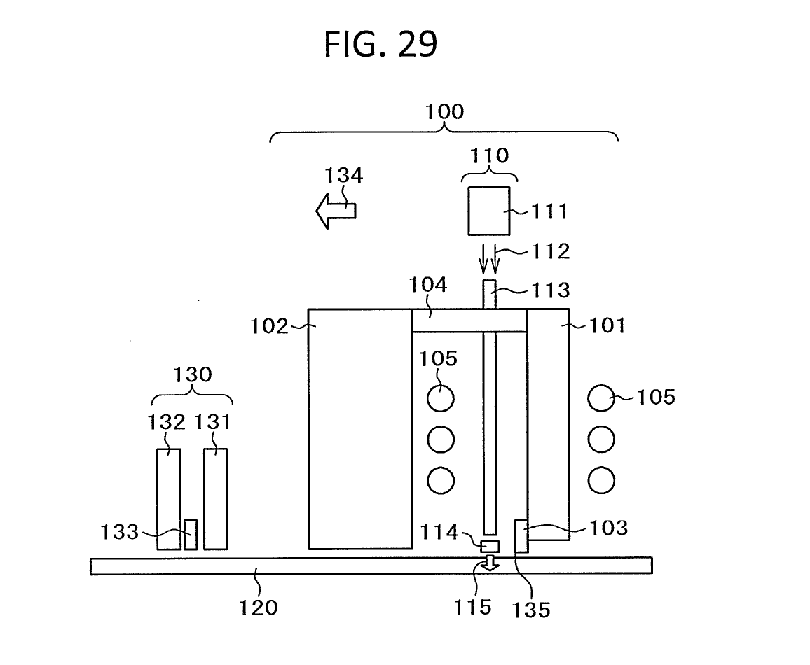

A seventh embodiment will be described referring to FIGS. 28 and 29. Any feature described in the first to the sixth embodiments which is not described herein is applicable unless the circumstances are exceptional.

FIG. 28 schematically illustrates an exemplary structure of a magnetic storage device. The magnetic recording medium according to the aforementioned embodiments is installed in the magnetic storage device shown in FIG. 28. Normally, a drive of a magnetic disk device has at least one magnetic recording medium 15 loaded therein. The magnetic recording medium 15 according to this embodiment is driven by rotation toward the direction (down-track direction) of an arrow 16. As an enlarged view showing an area around a magnetic head slider 17 of FIG. 28 illustrates, a magnetic head 18 at a rear end of the magnetic head slider 17 fixed to a top end of a carriage 19 is allowed to access an arbitrary track by a voice coil motor 20 so as to record and reproduce information on the magnetic recording medium.

FIG. 29 is a sectional view schematically illustrating an exemplary structure of a write head used in the thermally assisted magnetic storage device. FIG. 29 illustrates a cross section of a structure around a write head 100 which is cut together with a read head 130 in a plane parallel with a medium film thickness direction (longitudinal direction in the drawing), and a medium running direction. The write head 100 includes an upper magnetic pole 101, a lower magnetic pole 102, and a main magnetic pole 103. The upper magnetic pole 101 and the lower magnetic pole 102 are connected with a connecting portion 104. A conductor pattern 105 is spirally formed on the upper magnetic pole 101, having both terminal ends drawn outside so as to be connected to a magnetic head drive circuit. The main magnetic pole 103 has one end connected to the upper magnetic pole 101. The upper magnetic pole 101, the lower magnetic pole 102, the main magnetic pole 103, the connecting portion 104, and the conductor pattern 105 constitute an electromagnet as an integrated whole. The driving current applies a recording magnetic field to a magnetic recording medium 120 around a top end part of the main magnetic pole 103. The write head 100 is provided with a near field light generator 110 between the upper magnetic pole 101 and the lower magnetic pole 102. Specifically, this indicates that the write head 100 moves toward an arrow mark 134 relative to the magnetic recording medium 120, and a head leading edge 135 is provided with the near field light generator 110. When a laser beam 112 with a wavelength of 780 nm emitted from a laser light source 111 passes through a light wave guide 113 to reach a metal scatterer 114 provided adjacent to the main magnetic pole on the surface opposite the recording medium, a near field light 115 is generated from a top end part of the metal scatterer 114. The magnetic recording medium 120 is then heated. Recording is carried out by applying the recording magnetic field to the heated magnetic recording medium 120. The write head with the aforementioned structure may be produced using the thin-film forming process and the lithography process. Meanwhile, the read head 130 includes a GMR (giant magnetoresistance effect) element or a TMR (tunnel magnetoresistance effect) element 133 between an upper shield 131 and a lower shield 132.

After heating the magnetic recording medium to 400 to 450° C. and applying the head magnetic field from 12 to 15 kOe through synchronization with the position of the recording region for recording, inverting the magnetizing direction of the recording region is succeeded in recording irrespective of the adjacent recording region.

The magnetic storage device shown in FIG. 28 loaded with the magnetic recording medium according to the respective embodiments ensures high recording density as well as a compact size equipment.

The present invention has been explained in detail with reference to the embodiments.

According to a first aspect of the present invention, a magnetic recording medium has a substrate and a magnetic recording layer formed on the substrate. The magnetic recording layer includes a recording region on which a magnetic material is formed as a bit pattern and a spacing layer which fills a peripheral area of the recording region with a first non-magnetic material with relatively higher thermal conductivity than the thermal conductivity of the magnetic material.

According to a second aspect of the present invention, a magnetic recording medium has a substrate and a magnetic recording layer formed on the substrate. The magnetic recording layer includes a recording region on which a magnetic material is formed as a bit pattern, a spacing layer which fills a peripheral area of the recording region with a first non-magnetic material, and a thin film interposed between the recording region and the spacing layer, and formed of a second non-magnetic material with relatively lower thermal conductivity than the thermal conductivity of the spacing layer.

According to a third aspect of the present invention, a magnetic storage device includes a unit for generating near field light and a magnetic recording medium which carries out a recording operation using light from the unit for generating near field light. The magnetic recording medium includes a magnetic recording layer having a recording region on which a magnetic material is formed as a bit pattern and a spacing layer which fills a peripheral area of the recording region with a first non-magnetic material with relatively higher thermal conductivity than the thermal conductivity of the magnetic material.

The present invention is not limited to the embodiments as described above, but includes various modified embodiments. For example, the embodiments have been explained in detail for describing the present invention comprehensively, and accordingly, the present invention is not limited to have all the structures as described above. It is possible to partially replace the structure of any one of the embodiments with that of other embodiment. It is also possible to add the structure of any one of the embodiments to that of another embodiment, allowing addition, elimination and replacement of the structure of any one of the embodiments to that of another embodiment.

What is claimed is:

1. A magnetic recording medium having a substrate and a magnetic recording layer formed on the substrate, wherein the magnetic recording layer includes a recording region on which a magnetic material is formed as a bit pattern and a spacing layer which fills a peripheral area of the recording region with a first non-magnetic material with relatively higher thermal conductivity than the thermal conductivity of the magnetic material.

2. The magnetic recording medium according to claim 1, wherein the first non-magnetic material has the thermal conductivity of 3 W/mK or higher.

3. The magnetic recording medium according to claim 2, wherein the first non-magnetic material is formed as a transparent material which contains one of elements including Mg, In, Sn and Zn.

4. A magnetic recording medium having a substrate and a magnetic recording layer formed on the substrate, wherein the magnetic recording layer includes a recording region on which a magnetic material is formed as a bit pattern, a spacing layer which fills a peripheral area of the recording region with a first non-magnetic material, and a thin film interposed between the recording region and the spacing layer, and formed of a second non-magnetic material with relatively lower thermal conductivity than the thermal conductivity of the spacing layer.

5. The magnetic recording medium according to claim 4, wherein the second non-magnetic material has relatively lower thermal conductivity than that of the magnetic material for forming the recording region.

6. The magnetic recording medium according to claim 5, wherein the thin film has a thickness larger than 0 nm and equal to or smaller than 2 nm.

7. The magnetic recording medium according to claim 6, wherein the second non-magnetic material contains any one of elements including Fe, Co, Al, Si, Ti and Cr.

8. The magnetic recording medium according to claim 1, wherein a total area of an upper surface and a lower surface of the recording region is smaller than a side surface area of the recording region.

9. The magnetic recording medium according to claim 4, wherein a total area of an upper surface and a lower surface of the recording region is smaller than a side surface area of the recording region.

10. The magnetic recording medium according to claim 1, wherein the recording region has a length equal to or shorter than 6 nm in a down-track direction.

11. The magnetic recording medium according to claim 4, wherein the recording region has a length equal to or shorter than 6 nm in a down-track direction.

12. The magnetic recording medium according to claim 1, wherein a material for forming an area just below the recording region has thermal conductivity lower than the thermal conductivity of the first non-magnetic material.

13. The magnetic recording medium according to claim 4, wherein a material for forming an area just below the recording region has thermal conductivity lower than the thermal conductivity of the first non-magnetic material.

14. A magnetic storage device including a unit for generating near field light and a magnetic recording medium which carries out a recording operation using light from the unit for generating near field light, wherein the magnetic recording medium includes a magnetic recording layer having a recording region on which a magnetic material is formed as a bit pattern and a spacing layer which fills a peripheral area of the recording region with a first non-magnetic material with relatively higher thermal conductivity than the thermal conductivity of the magnetic material.

15. The magnetic storage device according to claim 14, wherein a thin film formed of a second non-magnetic material with relatively lower thermal conductivity than the spacing layer is provided between the recording region and the spacing layer.
